(19) United States
(12) Patent Application Publication
(10) Pub. No.: US 2022/0042859 A1
(43) Pub. Date: Feb. 10, 2022

(54) High-sensitivity single-crystal fiber temperature measurement method based on the acoustic anisotropy and doping modulation of single-crystal fibers

(71) Applicant: SHANDONG UNIVERSITY, Jinan (CN)

(72) Inventors: Zhitai JIA, Jinan (CN); Tao WANG, Jinan (CN); Jian ZHANG, Jinan (CN); Yang LI, Jinan (CN); Yanru YIN, Jinan (CN); Xutang TAO, Jinan (CN)

(21) Appl. No.: 17/447,548

(22) Filed: Sep. 13, 2021

(30) Foreign Application Priority Data
Mar. 1, 2021 (CN) 202110238807.9

(51) Int. Cl. G01K 11/24; G01K 11/3206

(52) U.S. Cl. CPC G01K 11/24; G01K 11/3206

(57) ABSTRACT

A high-sensitivity single-crystal fiber temperature measurement method based on the acoustic anisotropy and doping modulation of single-crystal fibers uses single-crystal fibers upon crystal orientation optimization and/or doping ion modification as the probes of ultrasonic temperature sensors. Through crystal orientation optimization and/or doping modification of the single-crystal fibers, the invention improves the density and structural disorders of the single-crystal fibers while maintaining their structural stability to reduce the propagation speed of the ultrasonic waves in single-crystal fibers in a high-temperature environment, thus increasing the delay time between the reflected signals of the sensitive areas and improve the sensitivity of temperature measurements.

A high-sensitivity single-crystal fiber temperature measurement method based on the acoustic anisotropy and doping modulation of single-crystal fibers

### CROSS REFERENCES

This application claims priority to Chinese Patent Application Ser. No. CN202110238807.9 filed on 1 Mar. 2021.

### TECHNICAL FIELD

The invention is related to a high-sensitivity single-crystal fiber temperature measurement based on the acoustic anisotropy and doping modulation of single-crystal fibers and belongs to the field of new materials and sensing.

### BACKGROUND ART

As aerospace, energy, and manufacturing develop rapidly, ultra-high temperature sensing has gradually become a research hotspot worldwide. For now, most of the sensors have certain limitations in ultra-high temperature sensing, and only a few are capable of ultra-high temperature sensing above 1800° C. Contact-type sensors represented by thermocouples are among the most widely used temperature measurement techniques in the industrial field. Featuring simple structures, convenient manufacturing, fast response speed, and high accuracy of temperature measurement, the thermocouples are suitable for most temperature fields below 1800° C. However, for those above 1800° C., their accuracy is susceptible to temperature drift and material deformation at high temperatures. Additionally, as they are mostly made of precious metals, which are easy to be oxidized in strongly oxidizing high-temperature fields, their accuracy and service life are greatly limited. Non-contact infrared thermometers based on the thermal radiation effect are also among the most widely used temperature measurement tetchiness in the industrial field. The non-contact temperature measurement method enables their use in ultra-high temperature fields above 2000° C. However, as they are very susceptible to ambient thermal radiation, which results in low accuracy of temperature measurement, they are unable to meet the demands of cutting-edge researches. Therefore, it is urgent to develop a stable and high-performance ultra-high temperature measurement technology.

Single-crystal fibers are a new kind of quasi-one-dimensionalfunctional crystal material. They have combined the advantages of traditional fiber materials and bulk crystals. With excellent mechanical properties, good thermal management capability, and stable physical and chemical properties, they have important application prospects in high-energy laser, temperature sensing, radiation detection, information communication, and advanced manufacturing. Particularly, the high-melting-point oxide single-crystal fibers represented by sapphire, spinel, and sesquioxide crystal are also potential high-temperature sensing media.

Existing fiber-optic temperature sensors are mainly optical sensors based on quartz glass fibers, including fluorescence type, blackbody radiation type, Raman distribution type and optical interference type (Bragg grating, Fabry-Perot interferometer, Michelson interferometer), which measure temperatures relying on the variations of spectral characteristics with temperatures and feature small size, compact structures, and fast response speed. However, restricted by the low melting points of the silica fibers, they can hardly be used in ultra-high-temperature environments. Additionally, their measurement errors will also increase significantly due to the stray light and low signal-to-noise ratio at high temperatures.

Given the limitations of traditional temperature measurement technologies, high-temperature sensors based on high-melting-point oxide single-crystal fibers have gradually attracted the attention of researchers. Single-crystal fiber ultrasonic temperature sensors are even considered as one of the sensors with the most potential to achieve “three high” (high temperature, high precision, and high stability) temperature measurements. According to the schematic diagram in FIG. 1, the sensors use high-melting-point crystal fibers as probes, the surfaces of which are processed with grooves to form sensitive areas, and measure temperatures by placing the sensitive areas in high-temperature environments and analyzing the changes of the ultrasonic propagation speed in the sensitive areas of single-crystal fibers with ambient temperatures. In 2017, the research team led by Professor Gao Wang of North University of China reported a single-crystal sapphire fiber ultrasonic temperature sensor, which achieved stable operation at 1600° C. with a measurement error of less than 1%. The sensitivity of a sensor is highly dependent on the ultrasonic propagation speed in the single-crystal fiber, among which the crystal structure, density, and elastic properties of the single-crystal fiber play a crucial role. Existing studies of single-crystal fiber ultrasonic temperature sensors are limited to sapphire fiber, and there is no profound study on the influence law of crystal anisotropy and doping modification, which makes it difficult to realize the targeted regulation of the sensor performance, limiting the further improvement of the sensor performance.

### DESCRIPTION OF THE INVENTION

In view of the shortcomings of the existing technologies, the invention presents a high-sensitivity single-crystal fiber temperature measurement method based on the acoustic anisotropy and doping modulation of single-crystal fibers.

Through orientation optimization and/or doping modification of single-crystal fibers, the invention obtains the optimal acoustic characteristics, on the basis of the original ultrasonic temperature measurement technologies, by optimizing the orientations of single-crystal fibers according to the acoustic anisotropy of the probe materials. Through doping modification, it reconditions the structures and density of the single-crystal fibers, trying to further optimize the acoustic characteristics while maintaining the macroscopic stability of the single-crystal fibers, to exploit the potential of the probe materials to the maximum and improve the sensitivity of the sensors significantly.

The technical solution of the invention is as follows:

A high-sensitivity single-crystal fiber temperature measurement method based on the acoustic anisotropy and doping modulation of single-crystal fibers, which uses single-crystal fibers upon crystal orientation optimization and/or doping ion modification as the probes of ultrasonic temperature sensors.

According to a preferred embodiment of the invention, the method uses single-crystal fibers upon doping ion modification only or those having undergone both crystal orientation optimization and doping ion modification as the probes of ultrasonic temperature sensors.

According to the most preferred embodiment of the invention, the method uses single-crystal fibers having undergone both crystal orientation optimization and doping ion modification as the probes of ultrasonic temperature sensors.

According to a preferred embodiment of the invention, the crystal orientations of the single-crystal fibers are <100>, <110>, <111>, <120>, or <112>. But the invention is not limited to this.

According to the most preferred embodiment of the invention, the crystal orientations of the single-crystal fibers are those with the minimum elastic modulus (Young modulus or shear modulus).

According to an embodiment of the invention, single-crystal fibers with specific crystal orientations, such as <100>, <110>, <111>, <120>, or <112>, are obtained with the directional seed crystal induced growth method.

According to a preferred embodiment of the invention, the doping ions used in the doping ion modification process of the single-crystal fibers are transition metal cations, rare-earth metal cations, or other cations that can be doped by the single-crystal fibers, or a combination of any of them. But the invention is not limited to this.

According to a preferred embodiment of the invention, the transition metal cations are one or more selected from among the Cr³⁺, Mn²⁺, Fe³⁺, Zn²⁺, Cu²⁺, and Sc³⁺. But the transition metal cations referred to in the invention are not limited to this.

According to a preferred embodiment of the invention, the rare-earth metal cations are one or more selected from among the Yb³⁺, Nd³⁺, Er³⁺, Dy³⁺, Lu³⁺, and Ho³⁺. But the rare-earth metal cations referred to in the invention are not limited to this.

According to a preferred embodiment of the invention, the other cations that can be doped by the single-crystal fibers are one or more selected from among the Mg²⁺, Al³⁺, Si⁴⁺, Ga³⁺, and Ca²⁺. But the invention is not limited to this.

According to a preferred embodiment of the invention, the doping modification is single doping or co-doping.

According to a preferred embodiment of the invention, the doping method is melt doping, ion injection, or ion diffusion. But the invention is not limited to this.

According to a preferred embodiment of the invention, the doping amount of the doping ions varies between 0.1 at % and 50 at %.

According to a further preferred embodiment of the invention, the doping amount of the doping ions varies between 0.5 at % and 10 at %.

According to the invention, the principle of improving sensor sensitivity by doping ion modification is as follows: an increase in the density and lattice disorder of the single-crystal fibers without changing the basic structural framework of the crystals can reduce the ultrasonic transfer velocity in the single-crystal fibers at high temperatures and increase the delay time between the reflected signals of the sensitive areas, thus improving the sensitivity. It can be applied to high-temperature measurements above 1800° C. and adjust the temperature sensitivity significantly.

According to a preferred embodiment of the invention, the said single-crystal fiber temperature measurement method measures temperatures by processing grooves on the surfaces of the probes to form sensitive areas, placing the sensitive areas in high-temperature environments, and analyzing the changes of the ultrasonic propagation velocity in the sensitive areas of single-crystal fibers with ambient temperatures.

According to a preferred embodiment of the invention, the single-crystal fibers used are high-melting-point oxide single-crystal fibers.

According to a further preferred embodiment of the invention, the single-crystal fibers are Al₂O₃, YAG, LuAG, MgAl₂O₄, ZrO₂, Lu₂O₃, Y₂O₃, Sc₂O₃, or HfO₂. But the invention is not limited to this.

According to a preferred embodiment of the invention, the single-crystal fibers are prepared mainly with the laser-heated pedestal growth (LHPG) method, the micro-pulling-down (μ-PD) method, and the edge-defined film-fed growth (EFG) method. But the invention is not limited to this.

According to a preferred embodiment of the invention, the single-crystal fibers have melting points higher than 1800° C.; according to a preferred embodiment, the melting points of the single-crystal fibers fall between 1800 and 3000° C.

According to a preferred embodiment of the invention, the diameters of the single-crystal fibers fall between 0.4 and 3 mm.

According to a preferred embodiment of the invention, the lengths of the single-crystal fibers vary between 10 and 100 cm.

The single-crystal fibers mentioned above are single-crystal fibers that have not undergone crystal orientation optimization and/or doping modification.

According to a preferred embodiment of the invention, the lengths of the sensitive areas vary between 1 and 90 cm.

According to a preferred embodiment of the invention, the depths of the grooves in the sensitive areas fall between 0.1 and 1 mm.

According to a preferred embodiment of the invention, the grooves of the sensitive areas are processed through machining, itching, or femtosecond laser cutting.

According to a preferred embodiment of the invention, the ultrasonic waves used for temperature measurement are P-waves or S-waves.

According to a further preferred embodiment of the invention, the ultrasonic waves used for high-sensitivity temperature measurement are S-waves.

The invention regulates the sensor sensitivity through orientation optimization of single-crystal fibers. Based on the acoustic anisotropy of crystals, it prepares single-crystal fibers with the lowest acoustic propagation speed and uses them as the probes to significantly increase the delay time between the reflected signals of the sensitive areas and improve the measurement sensitivity.

The beneficial effects of the invention are as follows:
1. Through orientation optimization and/or doping modification of single-crystal fibers, the invention obtains the optimal acoustic characteristics, on the basis of the original ultrasonic temperature measurement technologies, by optimizing the orientations of single-crystal fibers according to the acoustic anisotropy of the probe materials. Through doping modification, it reconditions the structures and density of the single-crystal fibers, trying to further optimize the acoustic characteristics while maintaining the macroscopic stability of the single-crystal fibers, which has significantly improved the sensitivity of the single-crystal fiber ultrasonic temperature sensors.
2. The invention has mastered the operating rules of the single-crystal fiber ultrasonic temperature sensors by studying the acoustic anisotropy of the single-crystal fibers and can select single-crystal fibers with different crystal orientations for sensing according to the demands of different temperature fields.
3. The invention is easily implementable as it needs no new material. Based on mature single-crystal fiber materials, it can obtain better sensing media through crystal orientation reconditioning and doping modification alone.

### BRIEF DESCRIPTION OF THE FIGURES

FIG. 1 is the schematic diagram of the single-crystal fiber ultrasonic temperature sensor.

FIG. 2A shows the MgAl₂O₄ single-crystal fibers with different orientations (LHPG melting zon.

FIG. 2B shows the MgAl₂O₄ single-crystal fibers with different (MgAl₂O₄ single-crystal fibers with different orientations).

FIG. 2C shows the MgAl₂O₄ single-crystal fibers with different orientations (Zn:MgAl₂O₄ single-crystal fibers with different doping concentrations).

FIG. 2D shows the MgAl₂O₄ single-crystal fibers with different orientations (Zn, Cr:MgAl₂O₄ single-crystal fibers).

FIG. 3A shows the elastic anisotropy of the MgAl₂O₄ single-crystal fibers (adopts Young modulus).

FIG. 3B shows the elastic anisotropy of the MgAl₂O₄ single-crystal fibers (adopt shear modulus).

FIG. 3C shows the elastic anisotropy of the MgAl₂O₄ single-crystal fibers (adopt another shear modulus).

FIG. 4 shows the sensitivity of MgAl₂O₄ single-crystal fiber ultrasonic temperature sensors with different orientations under the P-wave conditions in Test Example 1.

FIG. 5 shows the sensitivity of MgAl₂O₄ single-crystal fiber ultrasonic temperature sensors with different orientations under the S-wave conditions in Test Example 1.

FIG. 6 shows the sensitivity of MgAl₂O₄ single-crystal fiber ultrasonic temperature sensors upon different concentrations of Zn²⁺ doping in Test Example 1.

FIG. 7 shows the sensitivity of MgAl₂O₄ single-crystal fiber ultrasonic temperature sensors upon 10 at % Zn²⁺ and 0.5 at % Cr³⁺ co-doping in Test Example 1.

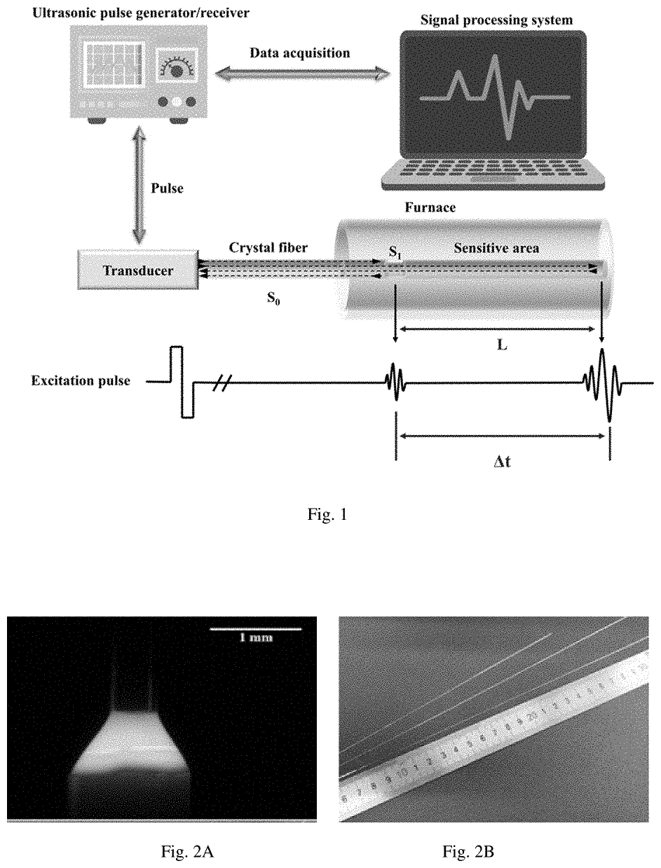

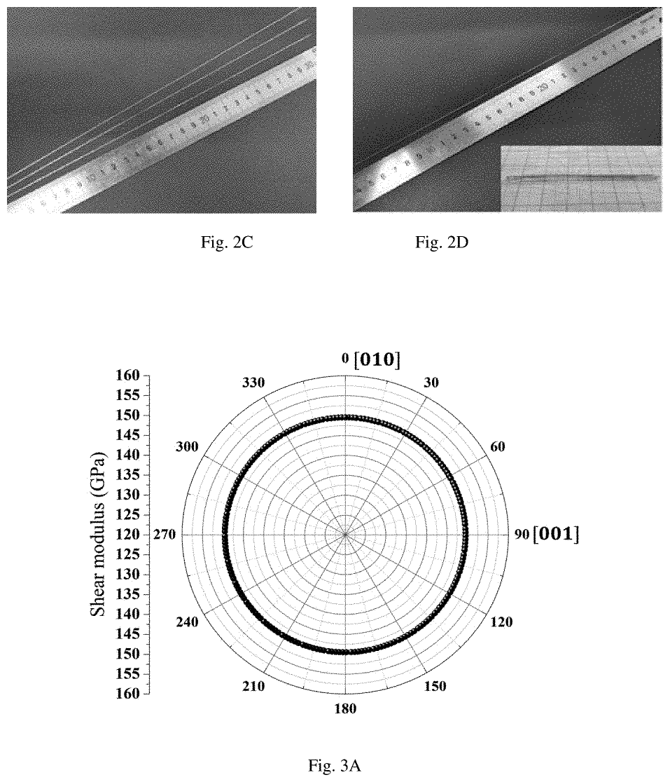

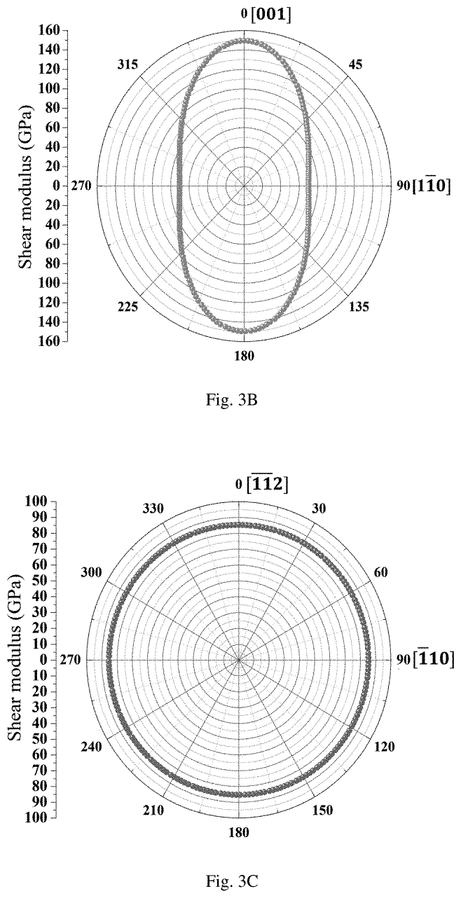

### DETAILED EMBODIMENTS

To clarify the purpose, the technical solution, and the advantages, the invention is further described as follows in combination with the specific embodiments. The embodiments set out here are used to explain the invention only, but not all.

### Embodiment 1

A high-sensitivity single-crystal fiber temperature measurement method based on the acoustic anisotropy and doping modulation of single-crystal fibers, which uses single-crystal fibers upon crystal orientation optimization as the probes of ultrasonic temperature sensors, processes grooves on the surfaces of the probes to form sensitive areas, and measures temperatures by placing the sensitive areas in high-temperature environments and analyzing the changes of the ultrasonic propagation speed in the sensitive areas of single-crystal fibers with ambient temperatures.

The said single-crystal fibers upon crystal orientation optimization are [100] MgAl₂O₄ single-crystal fibers with a diameter of 0.5 mm and a length of 300 mm. The sensitive areas are 200 m long with a groove depth of 0.1 mm and use P-waves as sensing waves.

### Embodiment 2

A high-sensitivity single-crystal fiber temperature measurement method based on the acoustic anisotropy and doping modulation of single-crystal fibers the same as the one said in Embodiment 1, provided that:

the orientation of the MgAl₂O₄ single-crystal fibers is [110].

### Embodiment 3

A high-sensitivity single-crystal fiber temperature measurement method based on the acoustic anisotropy and doping modulation of single-crystal fibers the same as the one said in Embodiment 1, provided that:

the orientation of the MgAl₂O₄ single-crystal fibers is [111].

### Embodiment 4

A high-sensitivity single-crystal fiber temperature measurement method based on the acoustic anisotropy and doping modulation of single-crystal fibers the same as the one said in Embodiment 1, provided that:

the Embodiment uses S-waves as sensing waves and [100] MgAl₂O₄ single-crystal fibers with a diameter of 0.5 mm and a length of 300 mm as probes, the sensitive areas of which are 200 mm long with a groove depth of 0.1 mm.

### Embodiment 5

A high-sensitivity single-crystal fiber temperature measurement method based on the acoustic anisotropy and doping modulation of single-crystal fibers the same as the one said in Embodiment 4, provided that: the orientation of the MgAl₂O₄ single-crystal fibers is [110].

### Embodiment 6

A high-sensitivity single-crystal fiber temperature measurement method based on the acoustic anisotropy and doping modulation of single-crystal fibers the same as the one said in Embodiment 4, provided that: the orientation of the MgAl₂O₄ single-crystal fibers is [111].

### Embodiment 7

A high-sensitivity single-crystal fiber temperature measurement method based on the acoustic anisotropy and doping modulation of single-crystal fibers, which uses single-crystal fibers having undergone crystal orientation optimization and doping modulation as the probes of ultrasonic temperature sensors, processes grooves on the surfaces of the probes to form sensitive areas, and measures temperatures by placing the sensitive areas in high-temperature environments and analyzing the changes of the ultrasonic propagation speed in the sensitive areas of single-crystal fibers with ambient temperatures.

The said single-crystal fibers having undergone crystal orientation optimization and doping modulation are [110] MgAl₂O₄ single-crystal fibers with a diameter of 0.5 mm and a length of 300 mm and upon 1 at % Zn²⁺ doping. The sensitive areas are 200 m long with a groove depth of 0.1 mm and use S-waves as sensing waves.

### Embodiment 8

A high-sensitivity single-crystal fiber temperature measurement method based on the acoustic anisotropy and doping modulation of single-crystal fibers the same as the one said in Embodiment 7, provided that: the doping concentration of Zn²⁺ is 5 at %.

### Embodiment 9

A high-sensitivity single-crystal fiber temperature measurement method based on the acoustic anisotropy and doping modulation of single-crystal fibers the same as the one said in Embodiment 7, provided that: the doping concentration of Zn²⁺ is 10 at %.

### Embodiment 10

A high-sensitivity single-crystal fiber temperature measurement method based on the acoustic anisotropy and doping modulation of single-crystal fibers the same as the one said in Embodiment 7, provided that:

the Embodiment uses S-waves as sensing waves and [110] MgAl₂O₄ single-crystal fibers with a diameter of 0.5 mm and a length of 300 mm and upon 10 at % Zn²⁺ and 0.5 at % Cr³⁺ co-doping as probes, the sensitive areas of which are 200 mm long with a groove depth of 0.1 mm.

Test Case 1

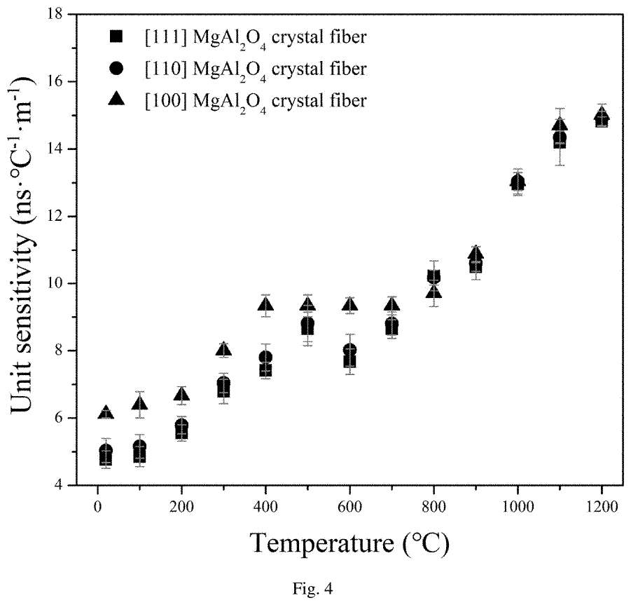

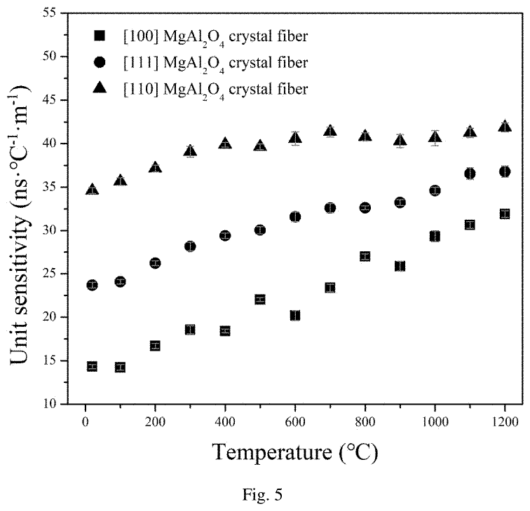

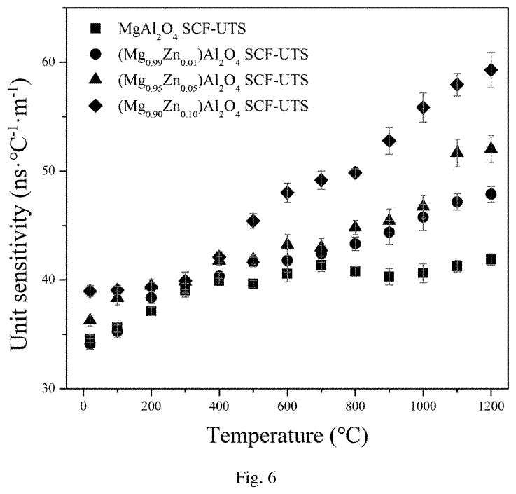

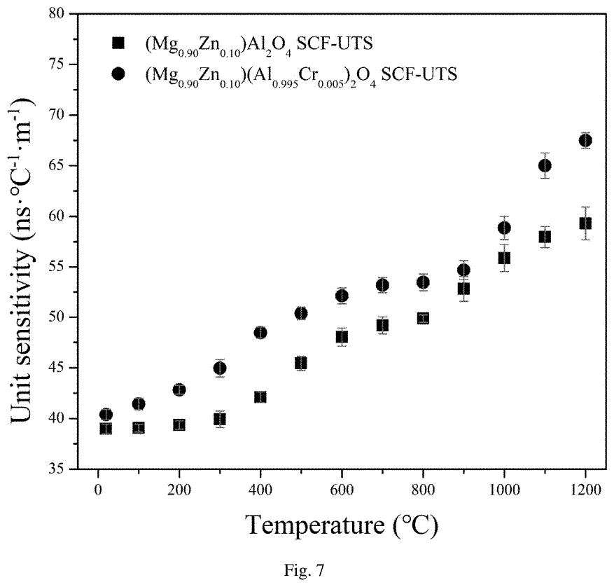

The ultrasonic sensing characteristics of Embodiments 1-10 were tested. FIGS. 4, 5, 6, and 7 show the sensor performance of Embodiments 1-3, Embodiments 4-6, Embodiments 7-9, and Embodiment 10 respectively. Table 1 shows the unit sensitivity of Embodiments 1-10 at 1200° C.

TABLE 1

| | Unit sensitivity at |
|---|---|
| No. | 1200° C. (ns · °C.⁻¹ · m⁻¹) |
| Embodiment 1 | 15.01 |
| Embodiment 2 | 14.91 |
| Embodiment 3 | 14.81 |
| Embodiment 4 | 31.91 |
| Embodiment 5 | 41.86 |
| Embodiment 6 | 36.79 |
| Embodiment 7 | 47.89 |
| Embodiment 8 | 52.02 |
| Embodiment 9 | 59.30 |
| Embodiment 10 | 67.49 |

As can be seen from Table 1, the sensitivity of single-crystal fiber ultrasonic temperature sensors is anisotropic in both P-wave and S-wave conditions, which is especially true under S-wave conditions, and the average sensitivity is higher. Therefore, the solution provided by the invention to improve the sensitivity of single-crystal fiber ultrasonic temperature sensors by reconditioning crystal orientations is feasible. Also, it is found that the sensitivity of MgAl₂O₄ single-crystal fiber ultrasonic temperature sensors increases significantly with the doping concentrations of Zn²⁺ ions, presenting a performance far better than the pure-phase MgAl₂O₄ single-crystal fiber ultrasonic temperature sensors. Upon co-doping, the sensitivity of the sensors is further improved, evidencing that doping ion modification is a feasible way to improve the sensitivity of single-crystal fiber ultrasonic temperature sensors.

What is claimed is:

1. A high-sensitivity single-crystal fiber temperature measurement method based on the acoustic anisotropy and doping modulation of single-crystal fibers, characterized in that it uses single-crystal fibers upon crystal orientation optimization and/or doping ion modification as the probes of ultrasonic temperature sensors.

2. The said temperature measurement method according to claim 1, characterized in that it uses single-crystal fibers upon doping ion modification only or those having undergone both crystal orientation optimization and doping ion modification as the probes of ultrasonic temperature sensors;
preferably, it uses single-crystal fibers having undergone both crystal orientation optimization and doping ion modification as the probes of ultrasonic temperature sensors.

3. The said temperature measurement method according to claim 1, characterized in that the crystal orientations of the single-crystal fibers are <100>, <110>, <111>, <120>, or <112>;
preferably, the crystal orientations of the single-crystal fibers are those with the minimum elastic modulus.

4. The said temperature measurement method according to claim 1, characterized in that the doping ions used in the doping ion modification process of the single-crystal fibers are transition metal cations, rare-earth metal cations, or cations that can be doped by the modified single-crystal fibers, or a combination of any two of them.

5. The said temperature measurement method according to claim 4, characterized in that the transition metal cations are one or more selected from among the Cr³⁺, Mn²⁺, Fe³⁺, Zn²⁺, Cu²⁺, and Sc³⁺;
the rare-earth metal cations are one or more selected from among the Yb³⁺, Nd³⁺, Er³⁺, Dy³⁺, Lu³⁺, and Ho³⁺;
the other cations that can be doped by the single-crystal fibers are one or more selected from among the Mg²⁺, Al³⁺, Si⁴⁺, Ga³⁺, and Ca²⁺.

6. The said temperature measurement method according to claim 1, characterized in that the doping modification is single doping or co-doping, and the doping method is melt doping, ion injection, or ion diffusion.

7. The said temperature measurement method according to claim 1, characterized in that the doping amount of the doping ions varies between 0.1 at % and 50 at % and is preferred to be between 0.5 at % and 10 at %.

8. The said temperature measurement method according to claim 1, characterized in that the said single-crystal fiber temperature measurement method measures temperatures by processing grooves on the surfaces of the probes to form sensitive areas, placing the sensitive areas in high-temperature environments, and analyzing the changes of the ultrasonic propagation speed in the sensitive areas of single-crystal fibers with ambient temperatures.

9. The said temperature measurement method according to claim 8, characterized in that the sensitive areas are 1-90 cm long with groove depths varying between 0.1 and 1 mm.

10. The said temperature measurement method according to claim 8, characterized in that the ultrasonic waves used for temperature measurement are P-waves or S-waves and preferred to be S-waves.

11. The said temperature measurement method according to claim 1, characterized in that the single-crystal fibers are high-melting-point oxide single-crystal fibers with melting points higher than 1800° C.

12. The said temperature measurement method according to claim 11, characterized in that the single-crystal fibers are Al₂O₃, YAG, LuAG, MgAl₂O₄, ZrO₂, Lu₂O₃, Y₂O₃, Sc₂O₃, or HfO₂.

13. The said temperature measurement method according to claim 1, characterized in that the diameters of the single-crystal fibers fall between 0.4 and 3 mm, and the lengths vary between 10 and 100 cm.
